(19) United States
(12) Patent Application Publication
(10) Pub. No.: US 2009/0224644 A1
(43) Pub. Date: Sep. 10, 2009

(54) Sliding lid for a refrigerator and/or freezer and refrigerator and/or freezer with a sliding lid

(76) Inventors: Richard Stocker, Lienz (AT); Richard Simoner, Nikolsdorf (AT)

Correspondence Address: DILWORTH & BARRESE, LLP, 1000 WOODBURY ROAD, SUITE 405, WOODBURY, NY, 11797, US

(21) Appl. No.: 12/288,965

(22) Filed: Oct. 24, 2008

(30) Foreign Application Priority Data
Oct. 6, 2007 (DE) UM202007014 831.3
Mar. 26, 2008 (DE) UM202008004150.3

(51) Int. Cl. F25D 23/02; E05D 15/00

(52) U.S. Cl. 312/405; 49/449

(57) ABSTRACT

The present invention relates to a sliding lid for a refrigerator and/or freezer, comprising a frame and a pane or plate connected with the frame, wherein the pane or plate is arched and one or more latching profiles are provided, which are connected with the frame by a latching connection such that the pane or plate is fixed between the frame and the latching profile(s).

### BACKGROUND OF THE INVENTION

The present invention relates to a sliding lid for a refrigerator and/or freezer, comprising a frame and a pane or plate connected with the frame. This invention furthermore relates to a refrigerator and/or freezer with a sliding lid.

From the prior art it is known that in chest refrigerators and/or freezers the space to be cooled is closed by a sliding lid which is composed of a frame and a generally transparent pane.

In solutions known from the prior art, the pane is fixed at the frame by bonding, welding, etc., in order to ensure a reliable hold of the pane on the frame. Such procedure for manufacturing a sliding lid is comparatively complicated and time- and cost-intensive.

### SUMMARY OF THE INVENTION

Therefore, it is the object underlying the invention to develop a sliding lid as mentioned above such that its manufacture is possible in a simple way.

This object is solved by a sliding lid with the features described herein. Accordingly, it is provided that the pane or plate is arched and that one or more latching profiles are provided, which are connected with the frame by a latching connection such that the pane or plate is fixed between the frame and the latching profile. In accordance with the invention, it thus is provided that fixing the pane or plate is effected by a latching connection between the frame and one or more latching profiles. Such latching system provides for an easy assembly. In a preferred aspect of the invention it is provided that no use is made of bonded or welded connections or other joining techniques other than a latching connection.

The pane or plate can directly or indirectly be connected with the frame and with the latching profile(s). It is conceivable, for instance, to provide sealing elements between frame and/or latching profile and pane. It is furthermore conceivable that the frame and the latching profile(s) directly act on the pane or plate, in order to hold the same.

The pane or plate has an upper surface and a lower surface, wherein the frame directly or indirectly adjoins the pane or plate on the upper or lower surface, and the latching profile adjoins the pane or plate on the other side thereof. It is conceivable, for instance, that in the edge region of the pane or plate the frame extends on the upper surface thereof, and the latching profile extends on the lower surface thereof.

On its lower surface, the frame can have a seat, which can be constitute a groove and in which a latching portion of the latching profile engages. In this case, the latching profile with the latching portion is connected with the frame from below. Other arrangements of the latching connection are of course also conceivable, such as a latching in the vicinity of the end face of the pane or plate or a latching in the vicinity of the upper surface of the frame.

In a further aspect of the invention it is provided that in the frame and/or on the latching profile one or more sealing elements are arranged. These sealing elements for instance can consist of sealing beads, which can be formed integrally with the frame or with the latching profile. The use of separate, i.e. not integrally connected sealing elements is also conceivable. These e.g. co-extruded or co-molded or also separate sealing elements can be provided to prevent an ingress of liquid, such as condensation water, into the frame of the sliding lid or into the region between frame and latching profile.

Furthermore, it can be provided that in particular in its outer region the frame includes a groove for receiving a sealing element. This sealing element serves to seal the lid against the carcass of the appliance, in or on which the sliding lid is movably mounted.

In a preferred aspect of the invention, a handle for actuating the sliding lid is mounted on the frame.

As explained above, a preferred aspect of the invention consists in that the sliding lid is fixed exclusively by means of said latching connection, i.e. further joining techniques, such as bonding, welding, etc. are omitted.

The frame and/or the latching profiles can be connected with the pane or plate in the entire or substantially the entire peripheral region thereof. What is conceivable is a continuous frame and one or more latching profiles, which extend parallel to the frame along the edge of the pane or plate.

In a preferred aspect, the frame is a one-piece frame. The same can consist for instance of extruded profiles, which are welded in the miter region. It is also possible to manufacture the frame as a part molded in one piece. In principle, the use of a multi-piece frame is also conceivable.

In a further aspect of the invention it is provided that one or also more latching profiles are provided. It is conceivable, for instance, to provide a latching profile for each side of the pane or plate. In principle, however, it is likewise conceivable to provide for instance one or more L-shaped latching profiles or one U-shaped or also continuous latching profile which is latched with the frame.

The latching profile(s) can be configured as elements separate from the frame. However, it is likewise conceivable to pivotally mount the latching profiles on the frame, for instance by means of a film hinge, and swivel the same after inserting the pane or plate and then latch the same with the frame.

The plate can be a pane or glass pane or also a plastic pane or also an insulation insert or insulation panel. The pane or plate preferably is transparent or translucent.

This invention furthermore relates to a refrigerator and/or freezer, in particular a chest refrigerator and/or freezer, wherein the appliance includes at least one space to be cooled, which can be closed by a sliding lid according to the description herein.

### BRIEF DESCRIPTION OF THE DRAWINGS

Further details and advantages of the invention will be explained in detail with reference to an embodiment illustrated in the drawing, in which:

FIG. 1: shows a perspective representation of the sliding lid in a view from above,

FIG. 2: shows a perspective representation of the sliding lid in a view from below,

FIG. 3: shows an enlarged representation of the corner region of the glass sliding lid in a view from below, and

FIG. 4: shows a sectional representation through the glass sliding lid in the edge region.

### DESCRIPTION OF THE PREFERRED EMBODIMENTS

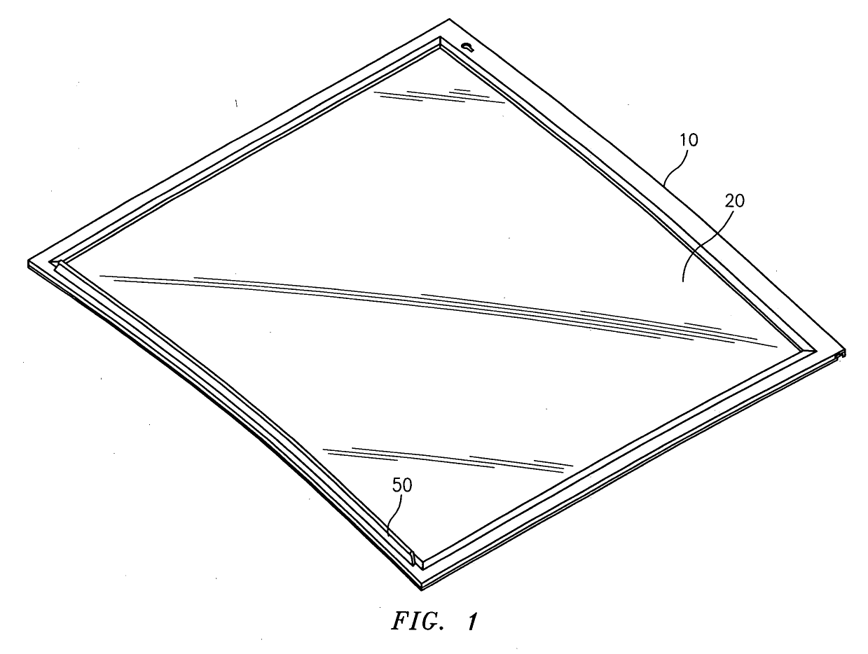

With reference numeral 10, FIG. 1 shows the one-piece and continuously formed frame, which can be made for instance of interconnected extruded profiles or can also constitute an a priori one-piece component.

In the frame 10, the arched glass pane 20 is received. Reference numeral 50 designates a handle mounted on the frame 10.

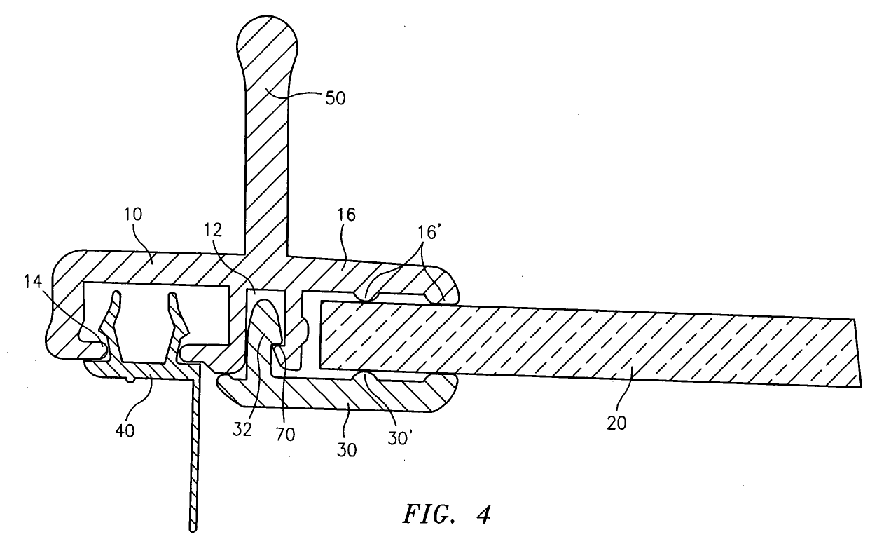

The frame includes a contour for receiving the glass pane 20, which is shown in FIG. 4. Reference numeral 16 designates a web which is part of the frame 10 and extends substantially horizontally. On its lower surface, said web 16 includes protrusions 16′, of which one is arranged in the terminal region of the web 16 and one is set back with respect to the same. As can be taken from FIG. 4, these webs 16′ sit on the upper surface of the edge region of the arched glass pane 20.

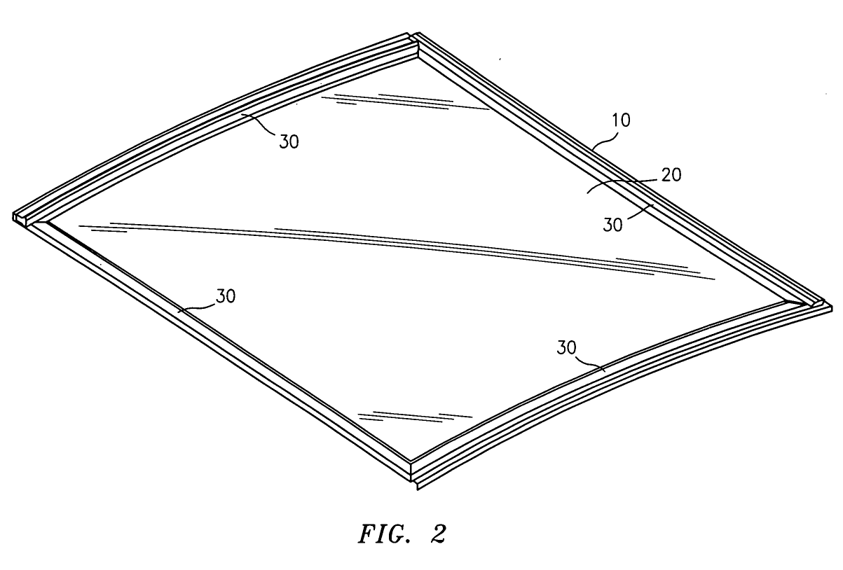

As can furthermore be taken from FIGS. 2, 3 and 4, latching profiles 30 adjoin the edge region of the glass pane 20 from below. These latching profiles 30 likewise have protrusions 30′, one of which is located in the terminal region of the latching profile 30 facing the pane 20 and the other one of which is set back with respect to the same.

As can furthermore be taken in particular from FIG. 4, a protrusion extends from the upper surface of the substantially plate-shaped latching profile 30, which serves as latching portion 32 of the latching profile 30. This latching portion 32 is received in a groove 12 of the frame 10, which is configured downwardly open.

One of the groove walls is configured with a protrusion directed towards the groove 12. As can furthermore be taken from FIG. 4, a protrusion of the latching portion 32 of the latching profile 30 rests on this protrusion such that the latching profile 30 cannot or at least not easily be removed from the groove 12. Thus, these protrusions secure the latching profile 30 in the groove 12 of the frame 10 by a positive connection 70.

As can furthermore be taken from FIG. 4, the latching portion 32 of the latching profile extends vertical from the substantially plate-shaped latching profile 30. The plate-shaped region of the latching profile 30 is configured approximately mirror-symmetrical with respect to the region 16 of the frame 10, which in the edge region of the pane 20 rests on the upper surface thereof.

Reference numeral 40 designates a sealing profile, which is received in a groove-like recess 14 of the frame 10.

FIG. 2 shows the arrangement in a perspective view from below and clearly illustrates that four latching profiles 30 are provided, wherein on each side of the pane 20 or plate one of the latching profiles 30 each is arranged, in order to fix the pane 20 or the plate in its edge region between the frame 10 and the respective latching profile 30.

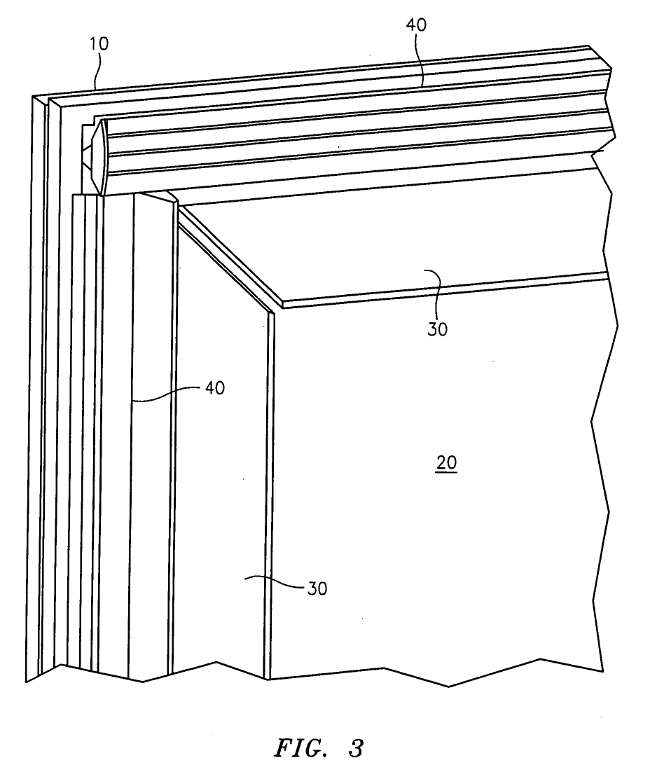

FIG. 3 shows a corner region of the sliding lid of FIG. 2 in greater detail. This Figure again illustrates the arrangement of the latching profiles 20 and of sealing profiles 40, which are mounted on the frame 10 by positive connection.

1. A sliding lid for a refrigerator and/or freezer, comprising a frame (10) and a pane (20) or plate connected with the frame (10), wherein the pane (20) or plate is arched and one or more latching profiles (30) are provided, which are connected with the frame (10) by a latching connection such that the pane (20) or plate is fixed between the frame (10) and the latching profile(s) (30).

2. The sliding lid according to claim 1, wherein the pane (20) or plate has an upper surface and a lower surface and the frame (10) adjoins and/or acts on the pane (20) or plate on the upper or lower surface, and the latching profile(s) (30) adjoin(s) and/or act(s) on the pane (20) or plate on the other side thereof.

3. The sliding lid according to claim 1, wherein the frame (10) includes a recess on its lower surface, in which a latching portion (32) of the latching profile(s) (30) engages.

4. The sliding lid according to claim 3, wherein the recess is a groove (12).

5. The sliding lid according to claim 1, wherein on the frame (10) and/or on the latching profile(s) (30) one or more sealing elements are arranged.

6. The sliding lid according to claim 5, wherein the sealing elements are integrally formed with the frame (10) and with the latching profile(s) (30).

7. The sliding lid according to claim 1, wherein the frame (10) includes a seat (14) for a sealing element (40).

8. The sliding lid according to claim 1, wherein the frame (10) includes a handle (50).

9. The sliding lid according to claim 1, wherein the pane (20) or plate is exclusively fixed between the frame (10) and the latching profile(s) (30) by the latching connection.

10. The sliding lid according to claim 1, wherein the frame (10) and/or the latching profile(s) (30) are connected with the pane (20) or plate on its entire periphery or substantially its entire periphery.

11. The sliding lid according to claim 1, wherein the frame (10) is formed in one piece.

12. The sliding lid according to claim 1, wherein one or more latching profiles (30) are provided.

13. The sliding lid according to claim 1, wherein the latching profile(s) (30) are pivotally mounted on the frame (10).

14. The sliding lid according to claim 1, wherein the pane (20) is a glass pane.

15. The sliding lid according to claim 1, wherein the plate is an insulating panel.

16. A refrigerator and/or freezer, in particular a chest refrigerator and/or freezer, wherein the appliance includes at least one space to be cooled, which can be closed by a sliding lid according to claim 1.

17. The sliding lid according to claim 2, wherein the frame (10) includes a recess on its lower surface, in which a latching portion (32) of the latching profile(s) (30) engages.

18. The sliding lid according to claim 17, wherein the recess is a groove (12).

19. The sliding lid according to claim 18, wherein on the frame (10) and/or on the latching profile(s) (30) one or more sealing elements are arranged.

20. The sliding lid according to claim 17, wherein on the frame (10) and/or on the latching profile(s) (30) one or more sealing elements are arranged.
